(19) United States
(12) Patent Application Publication
(10) Pub. No.: US 2014/0281234 A1
(43) Pub. Date: Sep. 18, 2014

(54) SERVING MEMORY REQUESTS IN CACHE COHERENT HETEROGENEOUS SYSTEMS

(71) Applicant: ADVANCED MICRO DEVICES, INC., Sunnyvale, CA (US)

(72) Inventors: Jason G. Power, Madison, WI (US); Bradford M. Beckmann, Redmond, WA (US); Steven K. Reinhardt, Vancouver, WA (US)

(73) Assignee: ADVANCED MICRO DEVICES, INC., Sunnyvale, CA (US)

(21) Appl. No.: 13/795,777

(22) Filed: Mar. 12, 2013

(51) Int. Cl. G06F 12/08

(52) U.S. Cl. CPC G06F 12/0815
USPC 711/122; 711/141

(57) ABSTRACT

Apparatus, computer readable medium, and method of servicing memory requests are presented. A read request for a memory block from a requester processing having a processor type may be serviced by providing exclusive access to the requested memory block to the requester processor when the requested memory block was modified a last time it was accessed by a previous requester processor having a same processor type as the processor type of the requester processor. Exclusive access to the requested memory block may be provided to the requester processor based on whether the requested memory block was modified by a previous processor having a same type as the requester processor at least once in the last several times the memory block was in a cache of the previous processor. Exclusive access to the requested memory block may be provided to the requester processor based on a region of the memory block.

### TECHNICAL FIELD

The disclosed embodiments are generally directed to servicing memory requests, and in particular, to servicing memory requests in cache coherent heterogeneous systems.

### BACKGROUND

Some systems have heterogeneous processors. For example, a system may have a central processing unit (CPU), which may include multiple cores, and may include graphical processing units (GPUs), which may also include multiple computing units. The CPUs and the GPUs may share the same memory, which may include caches. Caches are smaller portions of the memory that require less time to access than the main memory and may be privately used by one or more processors. Portions of the main memory are copied into the caches of the CPUs and GPUs. The multiple copies of the portions of main memory being used by different processors requires methods for how to keep the caches and main memory consistent or coherent with one another. Often, keeping the caches and main memory coherent can cause extra messages and extra copying of portions of the main memory. Sending the messages and copying portions of the main memory may slow the system down.

### SUMMARY OF EMBODIMENTS

Some embodiments provide a method of servicing a read request. The method includes responding to receiving the read request for a memory block from a requester processor having a processor type by providing exclusive access to the requested memory block to the requester processor when the requested memory block was modified the last time it was accessed by a previous requester processor having a same processor type as the processor type of the requester processor. The method includes providing read access to the requested memory block to the requester processor when the requested memory block was not modified a last time it was accessed by a previous requester processor having a same processor type as the processor type of the requester processor.

Some embodiments provide a method of servicing a read request for memory having regions. The method includes responding to receiving the read request for a memory block having a region from a requester processor having a processor type by providing exclusive access to the requested memory block to the requester processor when a last accessed second memory block from the region was modified a last time it was accessed by a previous requester processor having a same processor type as the processor type of the requester processor. Otherwise, the method responds by providing read access to the requested memory block to the requester processor. The previous requester processor and the requester processor may be a same processor.

The method may include providing exclusive access to the requested memory block to the requester processor when a bit associated with the last accessed second memory block indicates that the last accessed second memory block was written to the last time it was accessed by the previous requester processor having the same processor type as the processor type of the requester processor, then providing exclusive access to the requested memory block to the requester processor.

Some embodiments provide a method of servicing a read request for regions. The method includes responding to receiving the read request for a memory block having a memory region by providing exclusive access to the memory block to the requester processor when a second requested memory block was modified a last time it was accessed by the requester processor, and the second requested memory block has a same memory region as the memory region of the requested memory block.

The method includes providing read access to the requested memory block to the requester processor when the requested memory block was not modified a last time it was accessed by a previous requester processor having a same processor region as the processor region of the requester processor.

Some embodiments provide an apparatus for servicing a read request. The apparatus includes a memory comprising a plurality of memory blocks. The apparatus includes a cache directory. The cache directory may be configured to respond to the read request from a core of one or more cores by providing exclusive access to a requested memory block of the plurality of memory blocks when the memory block was modified the last time the memory block was accessed by any of the cores of the one or more cores. The cache directory may be configured to respond to the read request from a computational element (CE) of one or more CEs by providing exclusive access to a requested memory block of the plurality of memory blocks when the memory block was modified the last time the memory block was accessed by any of the CEs of the one or more cores.

Some embodiments provide a method of servicing a read request. The method includes responding to receiving the read request for a memory block from a requester processor having a processor type by providing exclusive access to the requested memory block to the requester processor when the requested memory block was modified a last several times it was accessed by a previous requester processor having a same processor type as the processor type of the requester processor. The method includes providing read access to the requested memory block to the requester processor when the requested memory block was not modified the last several times it was accessed by a previous requester processor having a same processor type as the processor type of the requester processor.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2 is a schematic diagram illustrating an example of an apparatus for serving memory requests in cache coherent heterogeneous systems, in accordance with some embodiments;

FIG. 3 is a schematic diagram of an example of a memory block entry according to some disclosed embodiments;

FIG. 4 illustrates a block of computer code that CPU and GPU may execute, in accordance to some disclosed embodiments;

FIG. 5 illustrates a diagram of the messages exchanged between the CPU L2 cache, the directory, and the GPU L2 cache during execution of the computer code, and an indication of memory block state, in accordance with some disclosed embodiments;

FIG. 6 illustrates a diagram of the messages exchanged between the CPU L2 cache, the directory, and the GPU L2 cache during execution of the computer code, and an indication of memory block state, according to some embodiments, where a shared state is upgraded to a state where the memory can be modified based on a processor type;

FIG. 7 illustrates a diagram of the messages exchanged between the CPU L2 cache, the directory, and the GPU L2 cache during execution of the computer code, and an indication of memory block state, according to some embodiments, where a share state is upgraded to a state where the memory can be modified without basing the upgrade on the processor type; and

FIG. 8 illustrates a method for serving memory requests in cache coherent heterogeneous systems in accordance with some embodiments.

### DETAILED DESCRIPTION OF EMBODIMENT(S)

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU) 128, which may include one or more cores (not illustrated), and a graphics processing unit (GPU) 130, which may include one or more compute units (not illustrated). The CPU 128 and GPU 130 may be located on the same die, or multiple dies. Each processor core may be a CPU 128 and each compute unit may be a GPU 130. The GPU 130 may include two or more single instruction multiple data (SIMD) processing units (not illustrated). The GPU 130 may include one or more computational elements (CEs). The GPU 130 and the CPU 128 may be other types of computational elements. A computational element may include a portion of the die that generates a memory request. The memory 104 may be located on the same die as the processor 102, or may be located separately from the processor 102. The memory 104 may include a volatile or non-volatile memory, for example, random access memory (RAM), dynamic RAM (DRAM), or a cache. The memory 104 may include one or more memory controllers 132. The memory controller 132 may be located on the same die as the CPU or another die. The memory 104 may include one or more caches 126. The caches 126 may be associated with the processor 102 or associated with the memory 104. The caches 126 and memory 104 may include communication lines (not illustrated) for providing coherency to the cache 126 and memory 104. The caches 126 and memory 104 may include a directory (not illustrated) for providing cache coherency as disclosed below. The caches 126 may include controllers (not illustrated) that are configured for coherency protocols.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

FIG. 2 is a schematic diagram illustrating an example of an apparatus for serving memory requests in cache coherent heterogeneous systems, in accordance with some embodiments. Illustrated in FIG. 2 are CPU 210, GPU 212, directory 250, memory controller 204, memory 202, and communication lines 206, 209, 210, 211.

The directory 250 receives memory block messages 276 which may be memory requests 270 from the L2 caches 218, 220 of the CPU 210 and the GPU 212, respectively, and responds to the memory block messages 276 with memory block messages 276. When the memory block message 276 is a memory request 270, then the directory 250 may look up the memory block address 272 in the memory block directory 256, which may result in the memory block 272 being allocated for read or write access to the cache 218, 220, and may result in the memory block 280 being sent to the requesting cache 218, 220. The directory 250, the caches 218, 220, and memory 202 may exchange memory blocks 280. The memory 202 may be a memory 104 as discussed above. The memory 202 may be accessed in memory blocks 280, which are accessed by an address 282. The memory block 280 may not explicitly include an address 282, but may be accessed by an address 282.

The CPU 210 includes one or more cores 214.1, 214.2, 214.3, L1 caches 216.1, 216.2, 216.3, and L2 cache 218. The cores 214 may be processing cores. The L2 cache 218 may be a shared cache that L1 caches 216 use in a hierarchical fashion. In some embodiments, the CPU 210 may not include an L1 cache 216, in which case, in some embodiments, the L2 cache 218 may be named an L1 cache. In some embodiments, the CPU 210 may not include an L2 cache 218, in which case the L1 cache 216 may be configured similarly to the L2 cache 218. In some embodiments, the CPU 210 may include one or more additional caches. Each of the cores 214 may generate memory requests 270. The term L1 and L2 are often used to refer to different levels in a hierarchical cache structure with L1 referring to level 1 and L2 referring to level 2. In some embodiments, there is more than one CPU 210.

The GPU 212 includes one or more computational entities CEs 224.1, 224.2, 224.3, L1 caches 222.1, 222.2, 222.3, and L2 cache 220. The CEs 224 may include two or more single instruction multiple data (SIMD) processing units (not illustrated). The L1 cache 222 may be a cache that is private to the SIMD processing units of the respective CE 224. In some embodiments, the L1 cache 222 may be a read only cache. The L2 cache 220 may be a cache that is shared by the L1 caches 222 in a hierarchical fashion. In some embodiments, the GPU 212 may not include an L1 cache 222, in which case, in some embodiments, the L2 cache 220 may be named an L1 cache. In some embodiments, the GPU 212 may not include an L2 cache 220, in which case the L1 cache 222 may be configured similarly to the L2 cache 220. In some embodiments, the GPU 210 may include one or more additional caches. Each of the CEs 224 may generate memory requests 270. The L2 caches 218, 220 may be configured to generate memory block messages 276 which may be memory requests 270 and to respond to memory block messages 276 with memory block messages 276. In some embodiments, there is more than one GPU 212.

The directory 250 includes memory request array 254, memory block directory 256, and memory block message storage 260. The memory request array 254 may be registers that are configured to hold memory block messages 276 which may be memory requests 270 for processing. The memory requests 270 may include a memory block address 272 and a request type 274. The memory block address 272 may be an address indicating a memory block 280 of memory 202. In some embodiments, the request type 274 may be one of get exclusive for write operations when the requester 210, 212 does not have a valid copy of the memory block with memory block address 272, get shared for read operations, upgrade/change to dirty for write operations when the requester 210, 212 does have a valid copy of the memory block with memory block address 272, and clean or dirty write-backs for evictions of memory blocks with memory block address 272 from a cache 218, 220 of a requester 210, 212.

The memory block directory 256 may be a directory of memory block entries 290 that is configured to take a memory block address 292 and return memory block status 294 for the memory block address 292. In some embodiments, the memory block directory 256 may be an associative memory where there may not be a memory block entry 290 for each memory block 280 in memory 202. In some embodiments, the memory block directory 256 includes a memory block entry 290 for each memory block 280 in memory 202.

Memory block message storage 260 is a storage area to hold memory block messages 276. Memory block messages 276 are sent to the L2 caches 218, 220 by the directory 250, and received by the directory 250 from the L2 caches 218, 220, and, in some embodiments, may be sent among the caches 218, 220. The memory block messages 276 are generated by the directory 256 and the L2 caches 218, 220, and may be based on the memory requests 270, the memory block directory 256, and received memory block messages 276. Additional examples of memory block messages 276 include messages to change the memory block state 293 of a memory block 280 in a cache, to send a memory block 280 to another cache, and to wait for a given number of caches to indicate they have invalidated a memory block 280.

The directory 250 may send a request over a communication line 211 for a memory block 280 to be sent to an L2 cache 219, 221 as part of a memory block message 276. The memory block 280 may be sent to the L2 cache 218, 220 either over communication line 210 or over another communication line (not illustrated) that may be a direct line or a communication bus to the L2 caches 218, 220. The directory 250 may be configured to monitor writes to memory 202 of memory blocks 280 from the L2 caches 218, 220. The directory 250 may be configured to maintain in a memory block entry 290 whether a processor 210, 212, modified a memory block 280 with memory block address 292 the last time a processor 210, 212, had the memory block 280 in a cache 218, 220, of the processor 210, 212, the last time the memory block 280 was in a cache 218, 220 of the processor 210, 212.

The directory 250 may be configured to maintain in memory block entry 290 a processor type 297 (see FIG. 3) which indicates whether a processor 210, 212, modified a memory block 280 with memory block address 292 the last time a processor 210, 212, had the memory block 280 with memory block address 292 in a cache 218, 220, of the processor 210, 212, based on a type of the processor 210, 212. For example, if core 214.3 modified a memory block 280, then the memory block entry 290 for the memory block 280 would indicate that the last time a CPU 210 type of processor had the memory block 280 in a cache 218, 220 of the CPU 210 that the CPU 210 modified the memory block 280. In embodiments, the processor type 297 may indicate whether a processor 210, 212, modified a memory block 280 with the memory block address 292 the last time a processor 210, 212, had the memory block 280 with memory block address 292 in a cache 218, 220, of the processor 210, 212 based on a region of the memory block 280 and whether or not a second memory block 280 from the same region was modified a last time the second memory block 280 was accessed. In embodiments, the directory 250 may be configured to determine whether or not the requested memory block 280 was modified at least once a last several times the requested memory block 280 was accessed by one or more previous requester processors 210, 212 having a same processor type 297 as the processor type 297 of the requester processor 210, 212. And, if so, then the directory may provide exclusive access to the requested memory block 280 to the requester processor 210, 212.

The directory 250 may be configured to determine whether to respond to a request from a cache 218, 220, by treating a request from the cache 218, 220, of a memory request 270 of a request type 274 of get share, to treating the request as if it were a request type 274 of get exclusive or get modified, based on whether or not a processor of the same type as the type of processor 210, 212, making the memory request 270 last modified the memory block 280 with memory block address 272, when the memory block 280 with memory block address 272 was last in a cache 218, 220 of the processor 210, 212. For example, if core 214.3 modified a memory block 280 the last time the memory block 280 was in a cache 218 of a core 214, then the directory 250 may determine to treat the request type 274 of a core 214.1 with a request type 274 of read as if it were a request type 274 of exclusive. Changing the request type 274 may lower the amount of traffic among the caches 218, 220, the directory 250, and memory 202.

Illustrated in FIG. 3 is an example of a memory block entry 290 according to some disclosed embodiments. The memory block status 294 may include a memory block state 293, an owner 295, a sharer list 296, and a processor type 297. The memory block state 293, may be a state of the memory block with memory block address 292. Example memory block states 293 include invalid (I), shared (S), owned (O) and modified/exclusive (M/E). The owner 295 may be an indication of a L2 cache 218, 220, or the directory 250, that is considered to own the memory block with memory block address 292. For example, the owner 295 could be a numerical value indicating a particular cache 218, 220, or the directory 250. The sharer list 296 may be a list of caches 218, 220 that are sharing the memory block with memory block address 292. For example, the sharer list 296 could be a string of bits with a bit for each cache 218, 220, and then the bit corresponding to the cache 218, 220 indicates whether the cache 218, 220 is sharing the memory block with the memory block address 292. The processor type 297 may be an indication of whether a type of processor 210, 212, modified the memory block the last time the memory block with memory block address 292 was in the cache 218, 220 of the processor 210, 212. For example, the processor type 297 may be two bits with the first bit indicating whether a CPU 210 modified the memory block 280 with memory block address 292 the last time the memory block 280 was in a cache of a CPU 210, and with the second bit indicating whether a GPU 212 modified the memory block 280 with memory block address 292 the last time the memory block 280 was in a cache of a GPU 212. In some embodiments, the memory block entry 290 may not include one or more of memory block state 293, owner 295, or sharer list 296. The memory block entry 290 may include a counter for maintaining a counter for the number of times the memory block entry 290 has been accessed since the last time it was modified. The counter may be reset after a threshold number of times.

FIG. 4 illustrates a block of computer pseudo-code that CPU 210 and GPU 212 may execute, in accordance to some embodiments. FIG. 5 illustrates a diagram of the messages exchanged between the CPU L2 cache 218, the directory 250, and the GPU L2 cache 220 during execution of the computer code 400, in accordance with some embodiments. Although, the caches are referred to as the CPU L2 cache 218 and the GPU L2 cache 220, the CPU L2 cache 218 and the GPU L2 cache 220 may be another cache of the CPU 210 or GPU 212, respectively. The diagram 500 includes memory block state 503, CPU L2 cache 218, directory 250, and GPU L2 cache 220. The vertical axes represent time progressing from the top to the bottom. The diagram 500 is divided into sequences 580, 582, 584, 586, 588, and 590 that are initiated by an L2 cache 218 or 220 servicing a memory request 270 from a core 214 of a CPU 210 or a CE 224 of a GPU 212, respectively.

The following explanation of an example according to some embodiments refers to FIGS. 2, 3, 4, and 5. The computer code 400 (FIG. 4) begins with CPU 210 writes to memory block 280 401. For example, an instruction (not illustrated) to initialize data in a memory block 280 may be executed by a core 214.1 of the CPU 210. An example of the instruction is X=0, where X is the data address and 0 is the initial value. The corresponding L1 cache 216.1 may not have a copy of the memory block 280 with the data having address X, so the L1 cache 216.1 requests the memory block 280 in a modified state from the L2 cache 218.

The L2 cache 218 does not have the data item so the L2 cache 218 generates a memory request 270 (FIG. 2) for the memory block 280 (FIG. 2) with a request type 274 (FIG. 2) of get modified at 502 and a memory block address 272 (FIG. 2) of the memory block 280, which is illustrated in diagram 500.

The directory 250 receives the memory request 270 and looks to see if the memory block 280 with memory block address 272 has a memory block entry 290 in memory block directory 256 at 504. In some embodiments, all the memory blocks 280 will have an entry in the memory block directory 256. The directory 250 will then respond to the memory request 274 of get modified by the CPU L2 cache 218 according to the memory block state 293 (FIG. 3.) In this case, we assume the memory block state 293 is invalid. The directory 250 changes the memory block state 293 to modified and sends the memory block 280 with the memory block address 272 to the CPU L2 cache 218 at 506. The directory 250 may have a copy of the memory block 280 in a cache associated with the directory 250. For example, the directory 250 may have a lowest level cache (not illustrated) associated with the directory 250, and the directory 250 may send the memory block 280 to the CPU L2 cache 218 at 506. In some embodiments, the directory 250 will instruct the memory 202 to send the memory block 280 to the cache associated with the directory 250 or to the CPU L2 cache 218. In some embodiments, the CPU L2 cache 218 will instruct the memory 202 to send the memory block 280 to the CPU L2 cache 218. The step of 502 may be repeated one or more times if computer code 401 references more than one memory block 280. The computer code 400 of 401: CPU writes to Memory Block may then be performed at 507 by a core 214 of the CPU 210 with a memory block state 503 of modified CPU 590. The memory block entry 290 for the memory block 280 may have a memory block state 293 of modified, an owner of CPU L2 cache 218, an empty sharer list 296, and a processor type of CPU indicating that the CPU 210 has modified the memory block 280 the last time it was in the cache 218 of the CPU 210. The memory block state 503 is then modified CPU 590, which indicates that the memory block state 293 at the directory 250 is modify with the owner 295 indicated as the CPU L2 cache 218.

The computer code 400 continues with do 402. The do is the beginning of a loop that will loop around from 402 through 406 as long as the condition in 406 is true. An example condition may be to continue so long as a user has not pressed a stop button.

The computer code 400 continues with 403: GPU reads from memory block 280. A CE 224 of the GPU 212 may execute the read instruction. The CE 224 may attempt to read from the memory block 280 from the L1 cache 222, which may not have the memory block 280. The L1 cache 222 may then request the memory block 280 from the L2 cache 220. The GPU L2 cache 220 may not have the memory block 280. The GPU L2 cache 220 may make a memory request 274 of get share to the directory 250 at 508. The directory 250 determines that the memory block state 293 is modified and that the CPU L2 cache 218 is the cache that is the owner 295 and has a modified copy of the memory block 280 at 510. The directory 250 forwards the information of the memory request 274 of the GPU L2 cache 220 to the CPU L2 cache 218 at 512, and sets the memory block state 293 to shared. The CPU L2 cache 218 receives the forwarded information of the memory request 274 and takes the following action at 514. The CPU L2 cache 218 changes the memory block state 293 of the memory block 280 to shared for the CPU L2 cache 218, sends the memory block 280 to the directory 250 at 516 and to the GPU L2 cache 220 at 518, so that the memory block 280 will be consistent among the different caches. In embodiments, the CPU L2 cache 218 may not send the memory block 280 to the directory 250. The computer code 403: GPU reads the memory block may then be executed at 520 by a CE 224 of the GPU 212 with a memory block state 503 of shared CPU and GPU 592.

The computer code 400 then continues with 404: GPU writes to the memory block. The GPU L2 cache 220 only has the memory block 280 in a shared state which means the GPU L2 cache 220 can only read the memory block 280 and not write to the memory block 280.

The GPU L2 cache 220 sends a memory request 274 of get modified to the directory 250 at 522. The directory 250 changes the memory block state 293 to modified at 524. The directory 250 sends a memory block message 276 to the CPU L2 cache 218 to invalidate the memory block 280 in the CPU L2 cache 218 at 526. The directory 250 sends a memory block message request 276 to the GPU L2 cache 220 at 528 that indicates the GPU L2 cache 220 has to wait for an acknowledgement from the CPU L2 cache 218 before writing to the memory block 280. The CPU L2 cache 218 changes its memory block state 293 to invalid at 530. The CPU L2 cache 218 sends a memory block message 276 to the GPU L2 cache 220 that it has invalidated the memory block 280 in the CPU L2 cache 218 at 532. The GPU L2 cache 220 then changes the memory block state 293 to modified at 534. A CE 224 of the GPU 212 can then perform the computer code 404: GPU writes to the memory block at 534. The memory block state 503 is modified GPU 594.

The computer code 400 continues with 405: CPU reads the memory block. The memory block 280 that is being read and modified is in a modified state in the GPU L2 cache 220 (see modify GPU 594). The CPU L2 cache 218 sends a memory request 274 of get shared to the directory 250 at 536. The directory 250 determines that the memory block 280 is in a modified state at the GPU L2 cache 220 at 538. The directory 250 sends a memory block message request 276 to the GPU L2 cache that forwards the memory request 274 of the CPU L2 cache 218 at 540. The GPU L2 cache 220 changes the memory block state 293 in its cache to shared at 542. The GPU L2 cache 220 sends the modified memory block 280 to the directory 250 at 544. The GPU L2 cache 220 sends the modified memory block 280 to the CPU L2 cache 218 at 546. The computer code 400 of 405: CPU reads the memory block may then be performed at 548 by a core 214 of the CPU 210 with a memory block state 503 of Shared CPU and GPU 596.

The computer code 400 may then continue to 406: while (condition). If the condition is true then the computer code 400 returns to 403: GPU reads from the memory block. The GPU L2 cache 220 may determine that the memory block 280 is in a shared state so that the GPU may read at 556. The computer code 403: GPU reads the memory block may then be executed at 556 by a CE 224 of the GPU 212 with a memory block state 503 of shared CPU and GPU 598.

The computer code 400 then continues with 404: GPU writes to the memory block. The following sequence is similar to the above sequence for computer code 400 at 404, because the memory block state 503 is in the same state of shared CPU and GPU 592, 598 prior to the computer code 400 at 404 being performed.

The GPU L2 cache 220 only has the memory block 280 in a shared state which means the GPU L2 cache 220 can only read the memory block 280 and not write to the memory block 280. The GPU L2 cache 220 sends a memory request 274 of get modified to the directory 250 at 558. The directory 250 changes the memory block state 293 to modified at 560. The directory 250 sends a memory block message 276 to the CPU L2 cache 218 to invalidate the memory block 280 in the CPU L2 cache 218 at 562. The directory 250 sends a memory block message 276 to the GPU L2 cache 220 at 564 that indicates the GPU L2 cache 220 has to wait for an acknowledgement from the CPU L2 cache 218 before writing to the memory block 280. The CPU L2 cache 218 changes its memory block state 293 to invalid at 566. The CPU L2 cache 218 sends a memory block message 276 to the GPU L2 cache 220 that it has invalidated the memory block 280 in the CPU L2 cache 218 at 568. The GPU L2 cache 220 then changes the memory block state 293 to modified at 570. A CE 224 of the GPU 212 can then perform the compute code 404: GPU writes to the memory block at 534. The memory block state 503 is modify GPU 599.

The computer code 400 will continue with 405: CPU reads the memory block, which will be the same sequence 586 as the 405: CPU reads the memory block at 580, since the memory block state 503 will be the same: modify GPU 599 and modify GPU 594. The computer code 400 will continue to loop around sequences 588, 590, and 586 until the condition in the loop at 406 of the computer code 400 is false.

FIG. 6 illustrates a diagram of the messages exchanged between the CPU L2 cache, the directory, and the GPU L2 cache during execution of the computer code with an indication of memory block state, according to some embodiments where a share state is upgraded to a state where the memory can be modified based on processor. Illustrated along the top of the diagram 600 are the memory block state 503, the CPU L2 cache 218, the directory 250, and GPU L2 cache 220.

The diagram 600 is divided into sequences 580, 582, 584, 586, 688, and 690 corresponding to computer code 400 lines 401, 403, 404, 405, 403, and 404, respectively. The computer code 400 lines are executed by a core 214 of a CPU 210 or a CE 224 of a GPU 212 which generate memory requests to L2 cache 218 or L2 cache 220, respectively. The sequences 580, 582, 584, 586, 688, and 690 illustrate the L2 cache 218 or L2 cache 220 getting a memory block 280 in the L2 cache 218 or L2 cache 220 in the necessary memory block state 293 to service the memory requests generated by the core 214 of a CPU 210 or the CE 224 of the GPU 212.

The sequences 580, 582, 584, 586 are the same as in FIG. 5. But, the sequences 688 and 690 are different. The following explains the sequences 688 and 690 in accordance with some embodiments.

After sequence 586, the computer code 400 may then continue to 406: while (condition). If the condition is true then the computer code 400 returns to 403: GPU reads from the memory block. By examining the processor type 297, the GPU L2 cache 220 may determine that the memory block 280 is in a shared state, but that the last time that a GPU 212 accessed the memory block 280 that the memory block 280 was modified. The GPU L2 cache 220 sends a memory request 274 of get modified to the directory 250 at 658. In embodiments, the GPU L2 cache 220 sends a memory request 274 of get share to the directory 250 at 658, and the directory 250 changes the memory request 274 to a get modified because the processor type 297 indicates that the memory block 280 was modified the last time a GPU 212 accessed the memory block.

The directory 250 changes the memory block state 293 to modified at 660. The directory 250 sends a memory block message 276 to the CPU L2 cache 218 to invalidate the memory block 280 in the CPU L2 cache 218 at 662. The CPU L2 cache 218 changes its memory block state 293 to invalid at 566. The CPU L2 cache 218 sends a memory block message 276 to the GPU L2 cache 220 that it has invalidated the memory block 280 in the CPU L2 cache 218 at 668. The GPU L2 cache 220 then changes the memory block state 293 to modified at 656. A CE 224 of the GPU 212 can then perform the compute code 403: GPU reads the data block at 656. The memory block state 698 is modify GPU 599 in contrast to the memory block state 503 of FIG. 5 of shared CPU and GPU 598.

The computer code 400 then continues with 404: GPU writes to the memory block. The GPU L2 cache 220 already has the memory block 280 in a modified state. A CE 224 of the GPU 212 can then perform the compute code 404: GPU writes to the memory block at 670. The memory block state 503 is modify GPU 599. So, by upgrading the memory request from a read to modify the memory block state 503 was already in modify so that cache requests may be reduced.

FIG. 7 illustrates a diagram of the messages exchanged between the CPU L2 cache, the directory, and the GPU L2 cache during execution of the computer code with an indication of memory block state, according to some embodiments where a share state is upgraded to a state where the memory can be modified based without basing the upgrade on the processor type. Illustrated along the top of the diagram 700 are the memory block state 503, the CPU L2 cache 218, the directory 250, and GPU L2 cache 220.

The diagram 700 is divided into sequences 580, 782, 784, 786, 788, and 790 corresponding to computer code 400 lines 401, 403, 404, 405, 403, and 404, respectively. The computer code 400 lines are executed by a core 214 of a CPU 210 or a CE 224 of a GPU 212 which generate memory requests to L2 cache 218 or L2 cache 220, respectively. The sequences 580, 782, 784, 786, 788, and 790 illustrate the L2 cache 218 or L2 cache 220 getting a memory block 280 in the L2 cache 218 or L2 cache 220 in the necessary memory block state 293 to service the memory requests generated by the core 214 of a CPU 210 or the CE 224 of the GPU 212.

The sequence 580 is the same as the sequence illustrated in FIG. 5. But, the sequences 782, 784, 786, 788 and 790 are different. The following explains the sequences 782, 784, 786, 788, and 790 in accordance with some embodiments.

After sequence 580, the computer code 400 continues with 403: GPU reads from memory block 280. A CE 224 of the GPU 212 may execute the read instruction. The CE 224 may attempt to read from the memory block 280 from the L1 cache 222, which may not have the memory block 280. The L1 cache 222 may then request the memory block 280 from the L2 cache 220. The GPU L2 cache 220 may not have the memory block 280. The GPU L2 cache 220 may upgrade a memory request 274 of get share, which would be all that would be necessary to service the pending memory request from the CE 224 to a get modified because the memory block 280 was modified by a processor without regard to the type of the processor the last time the memory block 280 was in cache.

The GPU L2 cache 220 sends a memory request 274 of get modified to the directory 250 at 722. In some embodiments, the GPU L2 cache 220 sends a memory request 274 of get share to the directory 250 at 722, and the directory 250 upgrades the memory request 274 to get modify because the memory block 280 was modified by a processor without regard to the type of the processor the last time the memory block 280 was in cache.

The directory 250 changes the memory block state 293 to modified at 724. The directory 250 sends a memory block message 276 to the CPU L2 cache 218 to invalidate the memory block 280 in the CPU L2 cache 218 at 726. The CPU L2 cache 218 changes its memory block state 293 to invalid at 730. The CPU L2 cache 218 sends a memory block message 276 to the GPU L2 cache 220 that it has invalidated the memory block 280 in the CPU L2 cache 218 and the message may include the memory block 280 at 732. The GPU L2 cache 220 then changes the memory block state 293 to modified at 720. A CE 224 of the GPU 212 can then perform the compute code 403:

GPU reads the memory block 280 at 720. The memory block state 503 is modify GPU 792.

The computer code 400 then continues with 404: GPU writes to the memory block. The GPU L2 cache 220 has the memory block 280 in a modified state so a CE 224 of the GPU 212 can perform the compute code 404: GPU writes to the memory block at 734. The memory block state 503 is modify GPU 794.

The computer code 400 continues with 405: CPU reads the memory block. A core 214 of the CPU 210 may execute the read instruction. The state of the memory block 280 in the L2 cache 218 will be invalid since the state of the memory block in the GPU L2 cache 220 is modified. The CPU L2 cache 218 may upgrade a memory request 274 of get share, which would be all that would be necessary to service the pending memory request from the core 214 to a get modified because the memory block 280 was modified by a processor without regard to the type of the processor the last time the memory block 280 was in cache. The CPU L2 cache 218 sends a memory request 274 of get modified to the directory 250 at 736. The directory 250 changes the memory block state 293 to modified at 738 with the owner 295 being changed from GPU L2 cache 220 to CPU L2 cache 218. The directory 250 sends a memory block message 276 to the GPU L2 cache 220 that forwards the information regarding the memory request 274 of the CPU L2 cache 218 at 740. The GPU L2 cache 220 changes its memory block state 293 to invalid at 742. The GPU L2 cache 218 sends a memory block message 276 to the CPU L2 cache 218 that it has invalidated the memory block 280 in the GPU L2 cache 220 and the message may include the memory block 280 at 746. The CPU L2 cache 218 then changes the memory block state 293 to modified at 748. A core 214 of the CPU 210 can then perform the compute code 405: CPU reads the memory block 280 at 748. The memory block state 503 is modify CPU 796.

The sequences 788 and 790 are the same as sequences 782 and 784 respectively. Upgrading a memory request 274 from get share to modify may generate a greater amount of traffic if the upgrade is not based on the type of processor that last modified the memory block 280. For example, sequence 786 upgrades to a modify status when only a read is required. This causes the next sequence 788 to include a transfer of the memory block 280 from the CPU L2 cache 218 to the GPU L2 cache 220.

FIG. 8 illustrates a method for serving memory requests in cache coherent heterogeneous systems in accordance with some embodiments. The method 800 begins with start 802. The method 800 continues with receive a read request for a cache block from a requester processor having a processor type 804. For example, the directory 250 receives a memory request 274 of get modified from the GPU L2 cache 220 at 658 of FIG. 6. The processor type in this case may be GPU. The directory 250 may be able to identify the processor type by an address of the GPU L2 cache 220. The method 800 continues with was the requested memory block modified by a processor having a same processor type as the processor type of the requester processor 806. For example, referring to FIG. 6 at 658, by examining the processor type 297, the GPU L2 cache 220 may determine that the memory block 280 is in a shared state, but that the last time that a GPU 212 accessed the memory block 280 that the memory block 280 was modified. Alternatively, the directory 250 may determine whether or not the memory block 280 was modified by a processor having a same processor type as the processor type of the requester processor. In some embodiments, the method 800 may determine whether or not the requested memory block was modified the last time it was accessed by a processor having a same processor type as the processor type of the requester processor.

The method 800 may continue with providing exclusive access to the requested memory block to the requester processor 808. For example, referring to FIG. 6 at 658, the GPU L2 cache 220 sends a memory request 274 of get modified to the directory 250 rather than a memory request 274 of get shared. Alternatively, the directory 250 may upgrade the memory request 274 from a get shared to a get modified or get exclusive.

In the alternative, if the test in 806 fails, then the method 800 continues with provide read access to the requested cache block to the requester processor. For example, referring to FIG. 6 at 536, the CPU L2 cache 218 sends a memory request 274 of get shared to the directory 250 at 536, because the memory block 280 was not modified the last time it was accessed by a processor of the type CPU.

In embodiments, the cache coherency may be based on broadcast messages where each of the caches 218, 220, and a cache associated with memory 202, which may be called the LLC cache, may monitor memory requests 270 and memory block messages 276. The caches 218, 220 may include an indication of the type of processor. Each of the caches 218, 220, and the LLC cache may maintain a separate indication of whether memory blocks were last modified by a type of processor.

In embodiments, the directory 250 may be configured to determine whether or not a second memory block 280 having a same region as the requested memory block 280 was modified by a processor of the same type as the requesting processor, and if the second memory block was modified by a processor of the same type as the requesting processor, then the memory request may be upgraded from a share request to an exclusive or modified request. In embodiments, the directory 250 may be configured to determine in which region a memory block 280 is located. In embodiments, the second memory block 280 may be the last memory block 280 accessed from a same region of memory as the requested memory block 280.

Many of the examples have included a single memory block; however, it is apparent that the examples can be extended to more than one memory block.

Various models have been devised to maintain cache coherency. It is apparent that the disclosed embodiments could be modified to accommodate different models used to maintain cache coherency.

In embodiments, the CPU 210 and GPU 212 may be different types of processors. For example, the CPU 210 may be a hyper-cube processor. Additionally, more than two processors may share the same memory 202.

In embodiments, the L2 cache 218, 220, and the directory 250 may be configured to change or upgrade the memory request 270 from a read to a modify based on a last several times the memory block 280 was in a cache 218, 220 of a processor 210, 212 having a type of CPU 210, GPU 212.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a graphics processing unit (GPU), a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the disclosed embodiments.

The methods or flow charts provided herein may be implemented in a computer program, software, or firmware incorporated in a computer-readable storage medium for execution by a general purpose computer or a processor. In some embodiments, the computer-readable storage medium is a non-transitory computer-readable storage medium. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of servicing a read request, the method comprising:
in response to the read request for a memory block from a requester processor having a processor type,
providing exclusive access to the requested memory block to the requester processor when the requested memory block was modified a last time it was accessed by a previous requester processor having a same processor type as the processor type of the requester processor.

2. The method of claim 1, further comprising:
providing read access to the requested memory block to the requester processor, when the requested memory block was not modified a last time it was accessed by a previous requester processor having a same processor type as the processor type of the requester processor

3. The method of claim 1, wherein the processor type is one of a central processor or a graphic processing unit processor.

4. The method of claim 1, wherein the previous requester processor and the requester processor are a same processor.

5. The method of claim 1, wherein providing exclusive access to the requested memory block to the requester processor comprises:
providing exclusive access to the requested memory block to the requester processor when a bit associated with the requested memory block indicates that the requested memory block was written to the last time it was accessed by the previous requester processor having the same type as the processor type of the requester processor.

6. The method of claim 1, wherein the method is performed by an L2 cache.

7. The method of claim 1, wherein the method is performed by a lowest level cache (LLC).

8. The method of claim 1, where the method is performed by an L2 cache and further comprising:
monitoring memory cache messages other L2 caches and maintaining a table of memory blocks based on the memory cache messages with an indication of whether or not the requested memory block was modified the last time it was accessed by the previous requester processor.

9. A method of servicing a read request, the method comprising:
in response to the read request for a memory block having a region from a requester processor having a processor type,
providing exclusive access to the requested memory block to the requester processor when a last accessed second memory block from the region was modified a last time it was accessed by a previous requester processor having a same processor type as the processor type of the requester processor.

10. The method of claim 9, further comprising:
providing read access to the requested memory block to the requester processor, when a last accessed second memory block from the region was modified a last time it was accessed by a previous requester processor having a same processor type as the processor type of the requester processor.

11. The method of claim 9, wherein the previous requester processor and the requester processor are a same processor.

12. The method of claim 9, wherein providing exclusive access to the requested memory block to the requester processor comprises:
providing exclusive access to the requested memory block to the requester processor when a bit associated with the last accessed second memory block indicates that the last accessed second memory block was written to the last time it was accessed by the previous requester processor having the same processor type as the processor type of the requester processor.

13. The method of claim 9, wherein the method is performed by a cache.

14. The method of claim 9, wherein the method is performed by a lowest level cache (LLC).

15. An apparatus for servicing a read request, the apparatus comprising:
a memory comprising a plurality of memory blocks;
a cache directory, wherein the cache directory is configured to:
respond to the read request from a core of one or more cores by providing exclusive access to a requested memory block of the plurality of memory blocks when the memory block was modified the last time the memory block was accessed by any of the cores of the one or more cores; and
respond to the read request from a computational element (CE) of one or more CEs by providing exclusive access to a requested memory block of the plurality of memory blocks when the memory block was modified the last time the memory block was accessed by any of the CEs of the one or more cores.

16. The apparatus of claim 15, further comprising:
wherein when responding to the read request from the core, the cache directory is configured to respond to the read request from a core of the one or more cores by providing exclusive access to a requested memory block of the plurality of memory blocks when the memory block was modified the last time the memory block was accessed by any of the cores of the one or more cores; and
wherein when responding to the read request from the CE, the cache directory is configured to respond to the read request from a CE of the one or more CE by providing exclusive access to a requested memory block of the plurality of memory blocks if the memory block was modified the last time the memory block was accessed by any of the CEs of the one or more CEs.

17. The apparatus of claim 16, wherein the cache directory is a L2 cache directory.

18. The apparatus of claim 16, wherein the cache directory is a lowest level cache (LLC).

19. The apparatus of claim 16, further comprising:
the one or more central processing units (CPU), each comprising one or more cores; and
the one or more graphical processing units (GPU), each comprising one or more computational elements (CE).

20. A method of servicing a read request, the method comprising:
in response to receiving the read request for a memory block from a requester processor having a processor type,
providing exclusive access to the requested memory block to the requester processor when the requested memory block was modified at least once a last several times the requested memory block was accessed by one or more previous requester processors having a same processor type as the processor type of the requester processor.

21. The method of claim 20, further comprising:
providing read access to the requested memory block to the requester processor, when the requested memory block was not modified at least once a last several times the requested memory block was accessed by one or more previous requester processors having a same processor type as the processor type of the requester processor

22. The method of claim 20, wherein the last several times is one of: two times to twenty times.

23. The method of claim 20, wherein the processor type is one of a central processor or a graphic processing unit processor.
